(19) United States
(12) Patent Application Publication
(10) Pub. No.: US 2024/0356258 A1
(43) Pub. Date: Oct. 24, 2024

(54) CONNECTOR ASSEMBLY, GARMENT, AND ELECTRICAL DEVICE WITH PAD

(71) Applicant: Japan Aviation Electronics Industry, Limited, Tokyo (JP)

(72) Inventor: Tetsuya KOMOTO, Tokyo (JP)

(21) Appl. No.: 18/583,060

(22) Filed: Feb. 21, 2024

(30) Foreign Application Priority Data
Apr. 19, 2023 (JP) 2023-068438

(51) Int. Cl. H01R 12/77; A41D 1/00; H01R 12/70

(52) U.S. Cl. CPC H01R 12/778; A41D 1/005; H01R 12/7011

(57) ABSTRACT

A connector assembly includes a sheet-like base that is flexible and includes a base body and a tag portion drawn from the base body, a terminal member disposed on a front surface of the base body, a wire disposed to extend from the front surface of the base body to a front surface of the tag portion, the wire having one end thereof connected to the terminal member and another end thereof extending to the front surface of the tag portion, and a connector mounted on the front surface of the tag portion and connected to the another end of the wire, and the tag portion is folded toward the base body such that a rear surface of the tag portion faces a rear surface of the base body, whereby the connector is disposed on the rear surface side of the base body.

### BACKGROUND OF THE INVENTION

The present invention relates to a connector assembly, in particular, to a connector assembly that is attached to a garment or another wearing article worn by a user.

The invention also relates to a garment and an electrical device with a pad, each of which includes a connector assembly.

In recent years, attention has been drawn to so-called smart clothes that can acquire user's biological data such as the heart rate and the body temperature only by being worn by the user. Such smart clothes have an electrode disposed at a measurement site, and when a wearable device serving as a measurement device is electrically connected to the electrode, biological data can be transmitted to the wearable device.

The electrode and the wearable device can be interconnected by, for instance, use of a connector connected to a wiring portion drawn from the electrode.

As a connector of this type, for example, JP 2022-80493 A discloses a connector shown in FIGS. 26 and 27. The connector includes a connector body 1 made of an insulating material. The connector body 1 includes a first insulator 3 disposed on a front surface of a garment 2 and a second insulator 4 disposed on a rear surface of the garment 2, and is attached to the garment 2 together with a tab sheet 5. The tab sheet 5 is used to reinforce the garment 2. A plurality of contacts 6 are retained by the first insulator 3, and the contacts 6 are connected to a wiring portion 7 disposed on the garment 2.

Using the connector as a garment-side connector, a module-side connector (not shown) is fitted to the garment-side connector, whereby biological data can be transmitted to a measurement module to enable measurements and other actions.

In the meantime, since the first insulator 3 and the second insulator 4 constituting the connector body 1 are made of an insulating material having low flexibility, and particularly, since the second insulator 4 is disposed on the rear surface of the garment 2, a user may feel uncomfortable, degrading comfortableness in wearing the garment 2.

### SUMMARY OF THE INVENTION

The present invention has been made in order to solve the conventional problem described above and aims at providing a connector assembly capable of suppressing deterioration in comfortableness in wearing even when the connector assembly is attached to a wearing article worn by a user.

The present invention also aims at providing a garment and an electrical device with a pad, each of which includes the connector assembly.

The connector assembly according to the present invention includes:
a sheet-like base that is flexible, the sheet-like base including a base body and a tag portion drawn from the base body; at least one terminal member disposed on a front surface of the base body;
at least one wire disposed to extend from the front surface of the base body to a front surface of the tag portion, the at least one wire having one end thereof connected to the at least one terminal member and another end thereof extending to the front surface of the tag portion; and
a connector mounted on the front surface of the tag portion and connected to the another end of the at least one wire,
wherein the tag portion is folded toward the base body such that a rear surface of the tag portion faces a rear surface of the base body, whereby the connector is disposed on the rear surface side of the base body.

The garment according to the present invention includes the above-described connector assembly, wherein the sheet-like base is formed of at least part of cloth of the garment.

The electrical device with a pad according to the present invention includes the above-described connector assembly, wherein the at least one terminal member is composed of an electrode having a pad-like shape.

### BRIEF DESCRIPTION OF THE DRAWINGS

FIG. 1 is a view showing an outer surface of a front body of a garment to which a connector assembly according to Embodiment 1 is attached.

FIG. 2 is a view showing an outer surface of a back body of the garment in Embodiment 1.

FIG. 3 is a view showing an inner surface of the front body of the garment in Embodiment 1.

FIG. 4 is an enlarged partial view showing the inner surface of the front body of the garment in Embodiment 1 before a connector is mounted thereon.

FIG. 5 is an assembly view of the connector in Embodiment 1.

FIG. 6 is a partial cross-sectional view showing the connector in Embodiment 1.

FIG. 7 is a cross-sectional view showing how a tag portion is folded in Embodiment 1.

FIG. 8 is a cross-sectional view showing a state where the tag portion is folded and sewn to a base body in Embodiment 1.

FIG. 9 is a view showing the outer surface of the front body of the garment in Embodiment 1 in a state where the tag portion is folded.

FIG. 10 is a view showing an outer surface of the front body of a garment to which a connector assembly according to Embodiment 2 is attached.

FIG. 11 is a view showing an outer surface of the back body of the garment in Embodiment 2.

FIG. 12 is a view showing the outer surface of the front body of the garment in Embodiment 2 before the connector is mounted thereon.

FIG. 13 is a cross-sectional view showing how the tag portion is folded to the back body side in Embodiment 2.

FIG. 14 is a cross-sectional view showing a state where the tag portion is folded to the back body side and sewn to the back body in Embodiment 2.

FIG. 15 is a view showing the outer surface of the back body of the garment in Embodiment 2 in a state where the tag portion is folded.

FIG. 16 is a view showing a garment in Embodiment 3.

FIG. 17 is a view showing the garment in Embodiment 3 in a state where the tag portion is folded.

FIG. 18 is a perspective view of an electrical device with pads to which a connector assembly according to Embodiment 4 is attached as viewed from an outer side.

FIG. 19 is a perspective view of the electrical device with pads in Embodiment 4 as viewed from a user's body side.

FIG. 20 is a perspective view of the electrical device with pads in Embodiment 4 before a connector is mounted thereon, as viewed from the user's body side.

FIG. 21 is a perspective view of the electrical device with pads in Embodiment 4 with a tag portion being folded, as viewed from an outer side.

FIG. 22 is a cross-sectional view showing how the tag portion is folded to the base body side in Embodiment 5.

FIG. 23 is a cross-sectional view showing a state where the tag portion is folded to the base body side and fixed to the base body in Embodiment 5.

FIG. 24 is a cross-sectional view showing how the tag portion is folded to the base body side in Embodiment 6.

FIG. 25 is a cross-sectional view showing a state where the tag portion is folded to the base body side and accommodated in a connector accommodation portion in Embodiment 6.

FIG. 26 is a perspective view of a conventional connector when viewed from an obliquely upper position.

FIG. 27 is a perspective view of the conventional connector when viewed from an obliquely lower position.

### DETAILED DESCRIPTION OF THE INVENTION

Embodiments of the present invention are described below based on the accompanying drawings.

### Embodiment 1

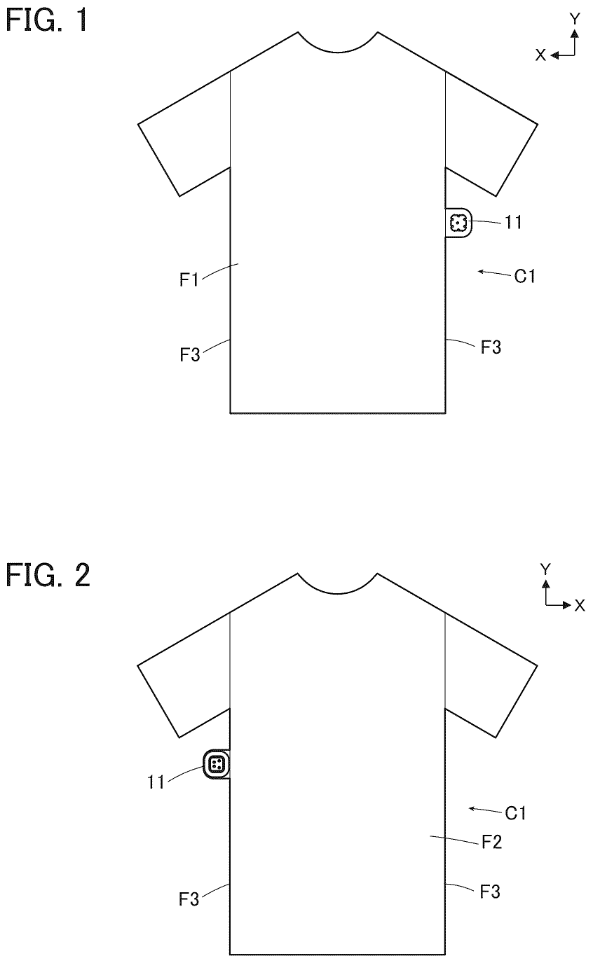

FIGS. 1 and 2 show a garment C1 to which a connector assembly according to Embodiment 1 is attached. The garment C1 is a so-called top such as a shirt a user wears, and is made of a front body F1 and a back body F2 sewn to each other at sewing portions F3 in their lateral parts. FIG. 1 shows an outer surface of the front body F1, and FIG. 2 shows an outer surface of the back body F2.

For convenience, the front body F1 and the back body F2 are defined as extending along an XY plane, the sewing portions F3 situated at opposite ends in the X direction are defined as extending along the Y direction, and a direction perpendicular to an XY plane is referred to as “Z direction.”

A connector 11 is attached to the garment C1 to protrude to an outside of the front body F1 and the back body F2 from their sewing portions F3 on the-X direction side among the sewing portions F3 situated at the opposite ends in the X direction.

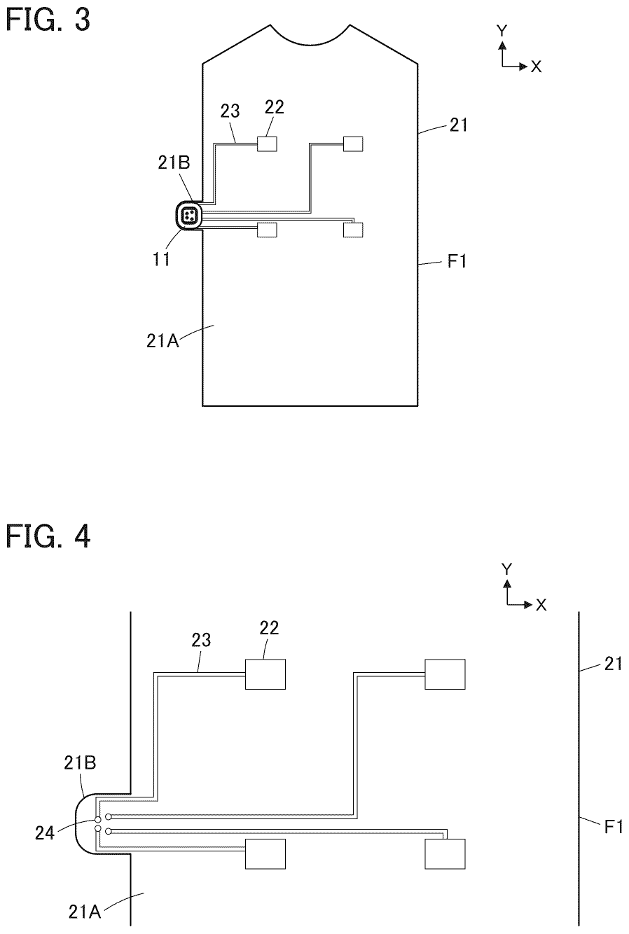

FIG. 3 shows an inner surface of the front body F1. The inner surface of the front body F1 is a surface that faces a user's body when the user wears the garment C1. Part of cloth of the garment C1 protrudes in the-X direction from the-X directional edge of the front body F1, and a sheet-like base 21 that is flexible is formed of the cloth of the garment C1 constituting this protruding portion and the front body F1.

The sheet-like base 21 includes a base body 21A formed of a part corresponding to the front body F1, and a tag portion 21B formed of a part corresponding to the protruding portion protruding in the-X direction from the −X directional edge of the front body F1.

To a front surface of the base body 21A that faces the user's body when the garment C1 is worn, a plurality of electrodes 22 constituting a terminal member are attached, and a plurality of wires 23 are also provided, one ends of which are separately connected to the electrodes 22, and the other ends of which extend to the tag portion 21B.

Meanwhile, the connector 11 is mounted on a front surface of the tag portion 21B forming a same plane as that of the front surface of the base body 21A. At the tag portion 21B, the other ends of the wires 23 are connected to the connector 11.

The connector assembly according to Embodiment 1 is composed of the sheet-like base 21, the electrodes 22 and the wires 23 attached to the front surface of the base body 21A, and the connector 11 mounted on the tag portion 21B shown in FIG. 3.

As shown in FIG. 4, the other ends of the wires 23 disposed on the front surface of the base body 21A extend to the front surface of the tag portion 21B and are separately connected to connecting portions 24 disposed on the tag portion 21B.

The electrodes 22 constituting the terminal member are used to acquire the user's biological data and disposed on the front surface of the base body 21A that faces the user's body when the garment C1 is worn, due to the necessity of being disposed in contact with or in the vicinity of the user's body surface. In alignment with the electrodes 22, the wires 23 are disposed on the front surface of the base body 21A.

Each electrode 22 can be made of a metal material and, besides, can be made by weaving or knitting a conductive thread. In addition, use may be made of an electrode 22 in which a conductive layer is formed through printing or another method on a front surface of an insulating resin film.

For each wire 23, a fibrous wire made by weaving or knitting a conductive thread can be used. Alternatively, for the wire 23, use may be made of one formed through printing or another method as a conductive layer on a front surface of an insulating resin film.

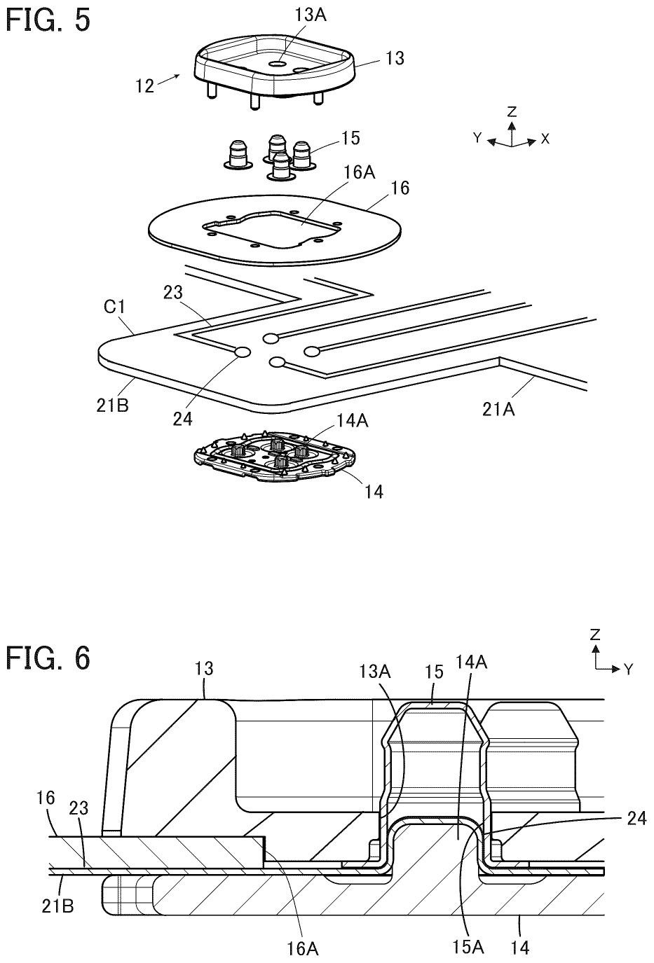

FIG. 5 shows an assembly view of the connector 11. The connector 11 is used as, for example, a garment-side connector portion for fitting a wearable device, and includes a first insulator 13 and a second insulator 14 forming a housing 12, a plurality of contacts 15 held by the housing 12, and a reinforcement sheet 16 for reinforcing the tag portion 21B of the garment C1.

On the front surface side of the tag portion 21B, the reinforcement sheet 16, the contacts 15, and the first insulator 13 are sequentially arranged, and on the rear surface side of the tag portion 21B, the second insulator 14 is arranged.

The first insulator 13 includes a plurality of through holes 13A in which the +Z directional parts of the contacts 15 are inserted, the second insulator 14 includes a plurality of projections 14A corresponding to the contacts 15 and projecting in the +Z direction, and the reinforcement sheet 16 is provided with an opening portion 16A at the center thereof.

For assembling the connector 11, the contacts 15 are separately arranged over the connecting portions 24 disposed on the front surface of the tag portion 21B, the reinforcement sheet 16 is arranged on the front surface of the tag portion 21B such that the contacts 15 are situated inside the opening portion 16A of the reinforcement sheet 16, and the first insulator 13 is arranged on the reinforcement sheet 16.

At this time, the +Z directional parts of the contacts 15 are separately inserted into the through-holes 13A of the first insulator 13 to project in the +Z direction from the first insulator 13.

In this state, the second insulator 14 is moved from the −Z direction to the +Z direction and is pressed against the first insulator 13, whereby the projections 14A of the second insulator 14 make contact with the rear surface of the tag portion 21B facing in the −Z direction, and the cloth of the garment C1 constituting the tag portion 21B and the connecting portions 24 disposed on the front surface of the tag portion 21B are pushed toward the +Z direction.

As a result, as shown in FIG. 6, each projection 14A of the second insulator 14 is inserted into a recess portion 15A formed in the corresponding contact 15 with the tag portion 21B being sandwiched therebetween. Consequently, the connecting portion 24 disposed on the front surface of the tag portion 21B is jutted in the +Z direction toward the recess portion 15A and deformed by the projection 14A, an inner peripheral surface of the recess portion 15A of the contact 15 makes contact with the connecting portion 24, and the contact 15 is electrically connected to the connecting portion 24.

The plurality of contacts 15 of the connector 11 are electrically connected to the plurality of electrodes 22 attached to the front surface of the base body 21A via the connecting portions 24 and the wires 23 in this manner.

Hence, for example, when a module-side connector (not shown) on which a predetermined electronic circuit is mounted is fitted to the connector 11, biological data acquired through the plurality of electrodes 22 can be measured by the electronic circuit or transmitted to a remote measurement device from the electronic circuit.

The connector 11 mounted on the tag portion 21B is not limited to the connector shown in FIGS. 5 and 6, and connectors having various structures can be mounted on the tag portion 21B.

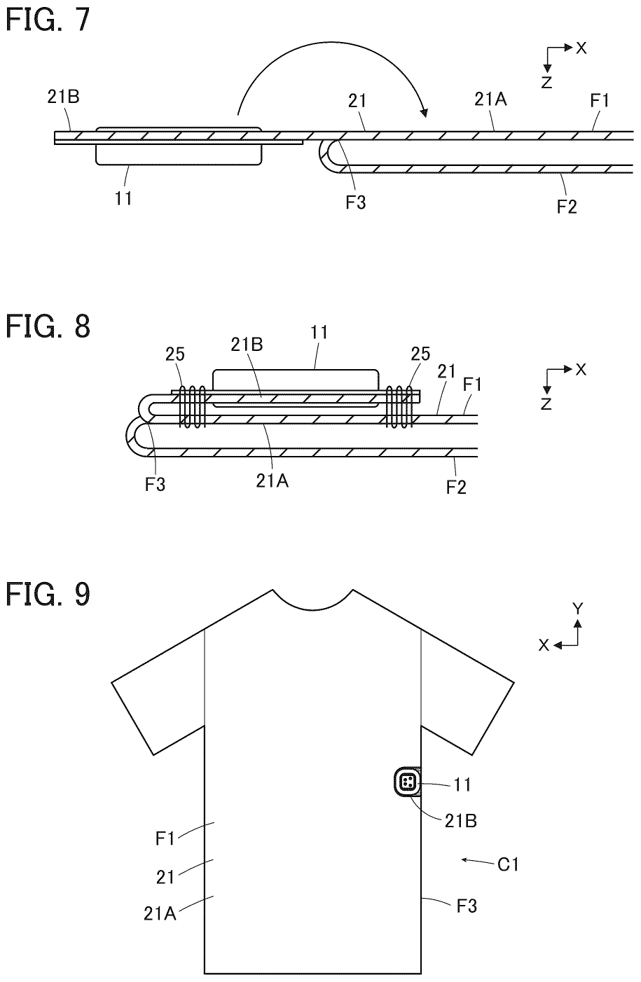

The front body F1 including the base body 21A is sewn to the back body F2 by use of the sewing portions F3, and the tag portion 21B protrudes to the-X direction side from the sewing portion F3 as shown in FIG. 7.

It is thus preferable that the tag portion 21B on which the connector 11 is mounted is folded toward the base body 21A at the sewing portion F3 such that the rear surface of the tag portion 21B faces the rear surface of the base body 21A, and is sewn to the base body 21A using a sewing thread 25 as shown in FIG. 8. Accordingly, the tag portion 21B is fixed to the base body 21A, and the connector 11 mounted on the tag portion 21B is disposed on the rear surface side, facing in the −Z direction, of the base body 21A, i.e., on an outer surface of the front body F1 as shown in FIG. 9.

According to Embodiment 1 described above, the plurality of electrodes 22 and the plurality of wires 23 are disposed on the front surface of the base body 21A of the sheet-like base 21, the connector 11 is mounted on the tag portion 21B protruding from the base body 21A to an outside of the base body 21A, and the tag portion 21B is folded toward the base body 21A such that the rear surface of the tag portion 21B faces the rear surface of the base body 21A, whereby the connector 11 is disposed on the rear surface side of the base body 21A. With this constitution, when the user wears the garment C1, the connector 11 is situated on the outside of the garment C1 with respect to the user's body; it is thus possible to acquire biological data via the electrodes 22 without degrading comfortableness in wearing the garment C1.

In addition, since the folded tag portion 21B is sewn and fixed to the base body 21A, even the garment C1 provided with the tag portion 21B on which the connector 11 is mounted can be worn without uncomfortable feeling.

In Embodiment 1, the connector assembly is formed in the front body F1 of the garment C1, but this is not the sole case, and the connector assembly can be formed in the back body F2. That is, the base body may be formed of cloth of the garment C1 constituting the back body F2, and part of the cloth of the garment C1 constituting the back body F2 may protrude to an outside of the back body F2 to form the tag portion, on which the connector 11 is mounted.

In addition, while in Embodiment 1, the plurality of electrodes 22 and the plurality of wires 23 are disposed on the front surface of the base body 21A, it suffices if at least one electrode 22 and at least one wire 23 are disposed.

### Embodiment 2

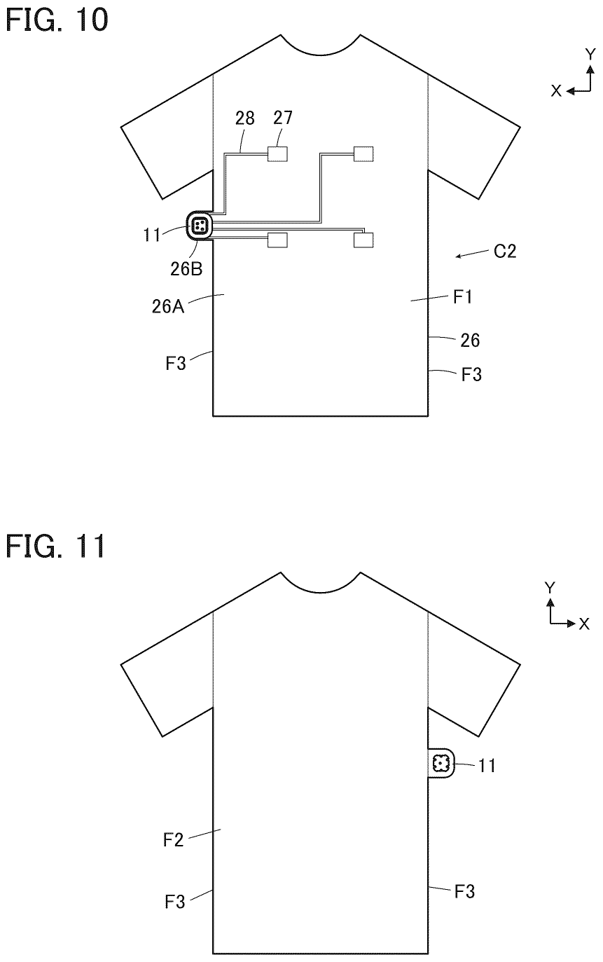

FIGS. 10 and 11 show a garment C2 to which a connector assembly according to Embodiment 2 is attached. As with the garment C1 in Embodiment 1, the garment C2 is a top a user wears, and is made of the front body F1 and the back body F2 sewn to each other at sewing portions F3 in their lateral parts. FIG. 10 shows an outer surface of the front body F1, and FIG. 11 shows an outer surface of the back body F2.

The connector 11 is attached to the garment C2 to protrude to an outside of the front body F1 and the back body F2 from their sewing portions F3 on the +X direction side among the sewing portions F3 situated at the opposite ends in the X direction.

The outer surface of the front body F1 shown in FIG. 10 is a surface that faces outward in the opposite direction from a user's body when the user wears the garment C2. Part of cloth of the garment C2 protrudes in the +X direction from the +X directional edge of the front body F1, and the flexible sheet-like base 26 is formed of the cloth of the garment C2 constituting this protruding portion and the front body F1.

The sheet-like base 26 includes a base body 26A formed of part corresponding to the front body F1, and a tag portion 26B formed of part corresponding to the protruding portion protruding in the +X direction from the +X directional edge of the front body F1.

To a front surface of the base body 26A that faces outward in the opposite direction from the user's body when the garment C2 is worn, a plurality of sensors 27 constituting a terminal member are attached, and a plurality of wires 28 are also provided, one ends of which are separately connected to the sensors 27, and the other ends of which extend to the tag portion 26B.

Meanwhile, the connector 11 is mounted on a front surface of the tag portion 26B forming a same plane as that of the front surface of the base body 26A. At the tag portion 26B, the other ends of the wires 28 are connected to the connector 11.

The connector assembly according to Embodiment 2 is composed of the sheet-like base 26, the sensors 27 and the wires 28 attached to the front surface of the base body 26A, and the connector 11 mounted on the tag portion 26B shown in FIG. 10.

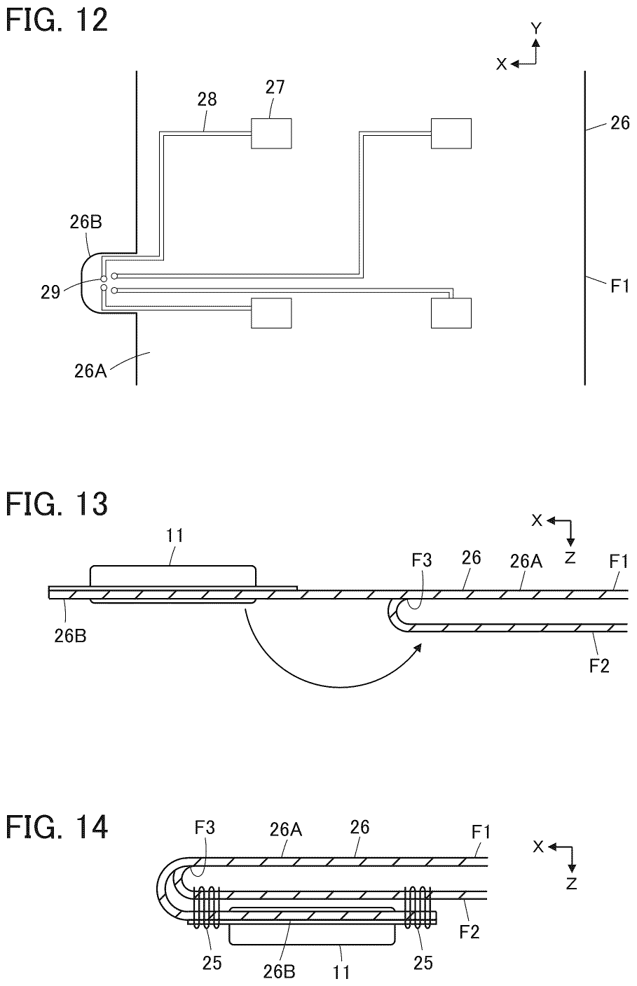

As shown in FIG. 12, the other ends of the wires 28 disposed on the front surface of the base body 26A extend to the front surface of the tag portion 26B and are separately connected to connecting portions 29 disposed on the tag portion 26B.

As the sensors 27 constituting the terminal member, angular rate sensors, acceleration sensors, and temperature sensors, for example, can be attached to the front surface of the base body 26A, and a module-side connector (not shown) on which a predetermined processor is mounted is fitted to the connector 11, whereby an inertial measurement unit for detecting three-dimensional inertial motion can be composed of the sensors 27 and the processor.

Since the sensors 27 as above need not be in contact with or in the vicinity of the user's body surface, in consideration of comfortableness in wearing the garment C2, the sensors 27 are preferably disposed on the front surface of the base body 26A facing outward in the opposite direction from the user's body when the garment C2 is worn, and the wires 28 are also disposed on the front surface of the base body 26A in alignment with the sensors 27.

The wires 28 are the same as the wires 23 used in Embodiment 1, and the connector 11 mounted on the tag portion 26B is also same as the connector 11 used in Embodiment 1.

The front body F1 including the base body 26A is sewn to the back body F2 by use of the sewing portions F3, and the tag portion 26B protrudes to the +X direction side from the sewing portion F3 as shown in FIG. 13.

It is thus preferable that the tag portion 26B on which the connector 11 is mounted is folded to the back body F2 side toward the base body 26A such that the rear surface of the tag portion 26B faces the rear surface of the base body 26A, and is sewn to the back body F2 using the sewing thread 25 as shown in FIG. 14.

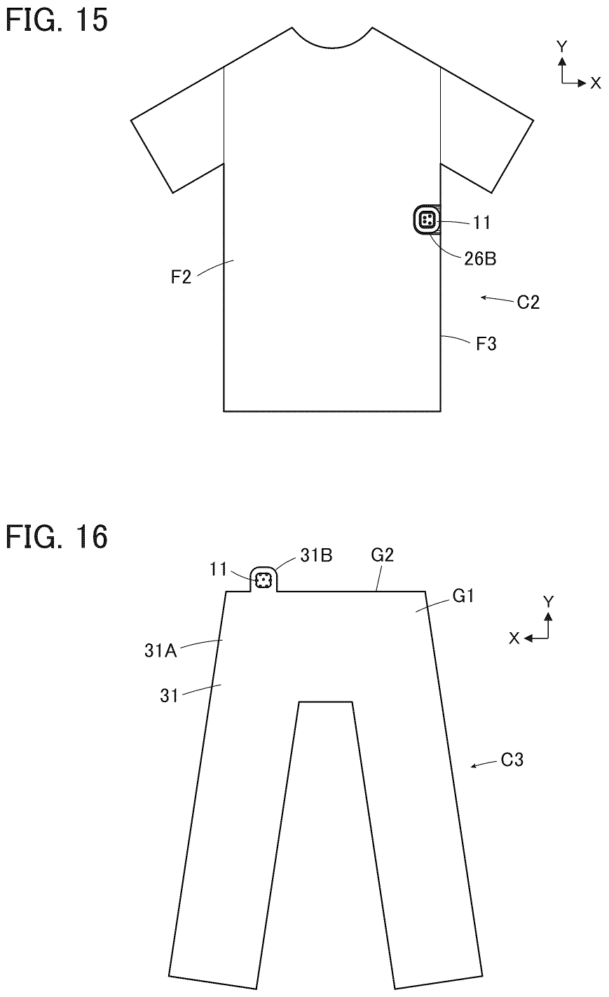

Since the tag portion 26B is sewn to the back body F2, the connector 11 mounted on the tag potion 26B is disposed on the rear surface side of the base body 26A, i.e., on an outer surface of the back body F2 as shown in FIG. 15.

According to Embodiment 2 described above, the plurality of sensors 27 and the plurality of wires 28 are disposed on the front surface of the base body 26A of the sheet-like base 26, the connector 11 is mounted on the tag portion 26B protruding from the base body 26A to an outside of the base body 26A, and the tag portion 26B is folded to the back body F2 side toward the base body 26A such that the rear surface of the tag portion 26B faces the rear surface of the base body 26A With this constitution, when the user wears the garment C2, the connector 11 is situated on the back side of the user and on an outside of the garment C2; it is thus possible to detect, for example, three-dimensional inertial motion using the sensors 27 without degrading comfortableness in wearing the garment C2.

In addition, since the folded tag portion 26B is sewn and fixed to the back body F2, even the garment C2 provided with the tag portion 26B on which the connector 11 is mounted can be worn without uncomfortable feeling.

In Embodiment 2, the connector assembly is formed in the front body F1 of the garment C2, but this is not the sole case, and the connector assembly can be formed in the back body F2.

In addition, while in Embodiment 2, the plurality of sensors 27 and the plurality of wires 28 are disposed on the front surface of the base body 26A, it suffices if at least one sensor 27 and at least one wire 28 are disposed.

### Embodiment 3

FIG. 16 shows a garment C3 to which a connector assembly according to Embodiment 3 is attached. The garment C3 is a so-call bottom such as a pair of pants or a skirt a user wears, and includes a waist portion G1, and an opening portion G2 adjacent to the waist portion G1.

Part of cloth of the garment C3 protrudes in the +Y direction from the opening portion G2 situated at the +Y directional end of the waist portion G1, and a flexible sheet-like base 31 is formed of cloth of the garment C3 constituting this protruding portion and the waist portion G1.

The sheet-like base 31 includes a base body 31A formed of part corresponding to the waist portion G1 and a tag portion 31B formed of part corresponding to the protruding portion protruding in the +Y direction from the opening portion G2, and the connector 11 is mounted on the tag portion 31B.

Although not shown in the drawings, as with Embodiment 1, a plurality of electrodes constituting a terminal member and a plurality of wires connected to the electrodes are disposed on a front surface of the base body 31A of the waist portion G1 facing the user's body when the garment C3 is worn, i.e., on an inner surface of the waist portion G1, and one ends of the wires extend to the tag portion 31B and are connected to the connector 11 at the tag portion 31B.

The connector assembly according to Embodiment 3 is composed of the sheet-like base 31, the electrodes and the wires disposed on the front surface of the base body 31A, and the connector 11 mounted on the tag portion 31B. The tag portion 31B on which the connector 11 is mounted is protruding in the +Y direction from the opening portion G2 of the garment C3 as shown in FIG. 16.

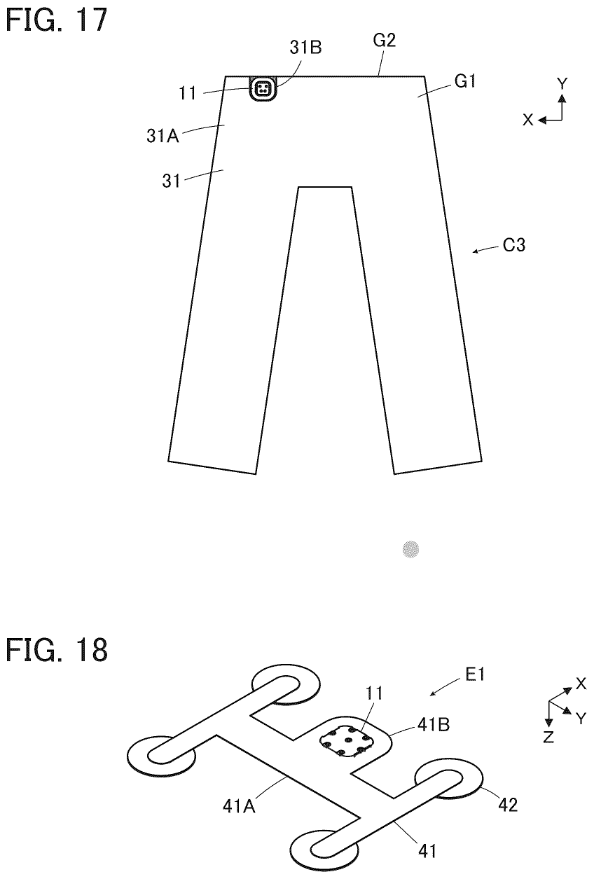

Hence, as shown in FIG. 17, the tag portion 31B on which the connector 11 is mounted is folded to the base body 31A side at the +Y directional end of the opening portion G2, specifically, to the outer surface side of the waist portion G1, and is sewn to the base body 31A as with Embodiment 1.

It is possible also in Embodiment 3 to acquire biological information via the electrodes without deteriorating comfortableness in wearing the garment C3, since the electrodes and the wires are disposed on the front surface of the base body 31A of the sheet-like base 31, the connector 11 is mounted on the tag portion 31B protruding in the +Y direction from the opening portion G2, and the tag portion 31B is folded toward the base body 31A such that the rear surface of the tag portion 31B faces the rear surface of the base body 31A, whereby the connector 11 is disposed on the rear surface side of the base body 31, i.e., on the outer surface side of the waist portion G1.

### Embodiment 4

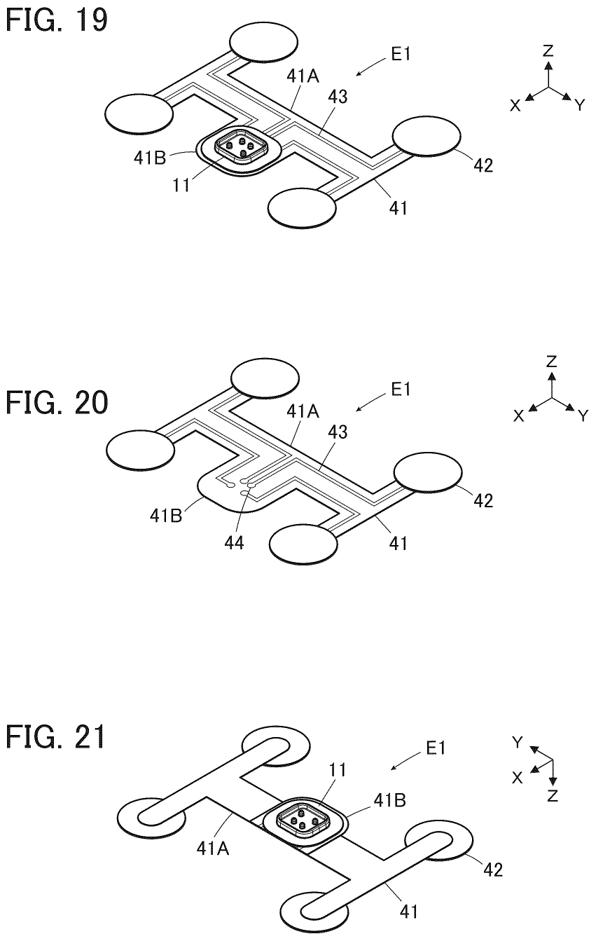

FIGS. 18 and 19 show an electrical device E1 with pads which includes a connector assembly according to Embodiment 4. The electrical device E1 with pads is a device that is directly or indirectly mounted to a user's body with use of an adhesive pad.

The electrical device E1 with pads includes a flexible sheet-like base 41 formed of, for example, an insulating resin film and extending along an XY plane. The sheet-like base 41 includes a base body 41A extending so as to form an H shape in an XY plane and a tag portion 41B protruding from a center part of the base body 41A toward an outside of the base body 41A in the +X direction.

FIG. 18 shows a rear surface of the sheet-like base 41 as viewed from an outer side of the electrical device E1 with pads mounted on the user's body, i.e., the opposite side from the user's body, and FIG. 19 shows a front surface of the sheet-like base 41 as viewed from an inner side of the electrical device E1 with pads mounted on the user's body, i.e., the user's body side.

As shown in FIG. 19, on the front surface of the sheet-like base 41, disposed are a plurality of electrodes 42 separately arranged at a plurality of end portions of the base body 41A of H shape, and a plurality of wires 43 with one ends thereof being separately connected to the electrodes 42 and the other ends thereof extending to the tag portion 41B.

In addition, the connector 11 is mounted on a front surface of the tag portion 41B forming a same plane as that of the front surface of the base body 41A. At the tag portion 41B, the other ends of the wires 43 are connected to the connector 11.

The connector assembly according to Embodiment 4 is composed of the sheet-like base 41, the electrodes 42 and the wires 43 disposed on the front surface of the base body 41A, and the connector 11 mounted on the tag portion 41B.

Each electrode 42 constitutes a terminal member and has a pad-like shape, forming an adhesive pad that sticks to, for example, the user's body surface. Specifically, the electrode 42 may be configured such that its conductive surface of pad-like shape is adhesive, or a conductor constituting the electrode 42 may be embedded in an adhesive pad.

For each wire 43, use can be made of one formed through printing or another method as a conductive layer on a front surface of the sheet-like base 41 made of an insulating resin film.

As shown in FIG. 20, the other ends of the wires 43 disposed on the front surface of the base body 41A extend to the front surface of the tag portion 41B and are separately connected to connecting portions 44 disposed on the tag portion 41B. By mounting the connector 11 on the tag portion 41B, four contacts 15 of the connector 11 are separately and electrically connected to the corresponding connecting portion 44.

The tag portion 41B on which the connector 11 is mounted is protruding in the +X direction from the center part of the base body 41A toward an outside of the base body 41A as shown in FIG. 18.

Thus, the tag portion 41B on which the connector 11 is mounted is folded to the outer side of the electrical device E1 with pads toward the base body 41A such that the rear surface of the tag portion 41B faces the rear surface of the base body 41A as shown in FIG. 21.

In addition, as with Embodiment 1, the folded tag portion 41B is preferably sewn to or bonded to the base body 41A.

It is possible also in Embodiment 4 to attach the electrical device E1 with pads to the user's body without uncomfortable feeling and to acquire biological information, since the electrodes 42 and the wires 43 are disposed on the front surface of the base body 41A of the sheet-like base 41, the connector 11 is mounted on the tag portion 41B protruding in the +X direction from the base body 41A, and the tag portion 41B is folded toward the base body 41A such that the rear surface of the tag portion 41B faces the rear surface of the base body 41A, whereby the connector 11 is disposed on the rear surface side of the base body 41A, i.e., on the outer side of the electrical device E1 with pads.

The electrical device E1 with pads is applicable to not only a device that acquires biological information of a user via the electrodes 42 but also devices including, for example, a so-called low-frequency therapy device that gives an electrical stimulus to a nerve or a muscle by applying an electric current to a user's body via the electrode 42 from a module-side connector (not shown) fitted to the connector 11 and a so-called electric muscle stimulation (EMS) device that constrainedly causes muscle movement by applying an electric current to a user's body.

### Embodiment 5

In Embodiment 1 described above, the tag portion 21B on which the connector 11 is mounted and which is folded is sewn to and thus fixed to the base body 21A as shown in FIG. 8, but the method of fixing the tag portion 21B to the base body 21A is not limited thereto.

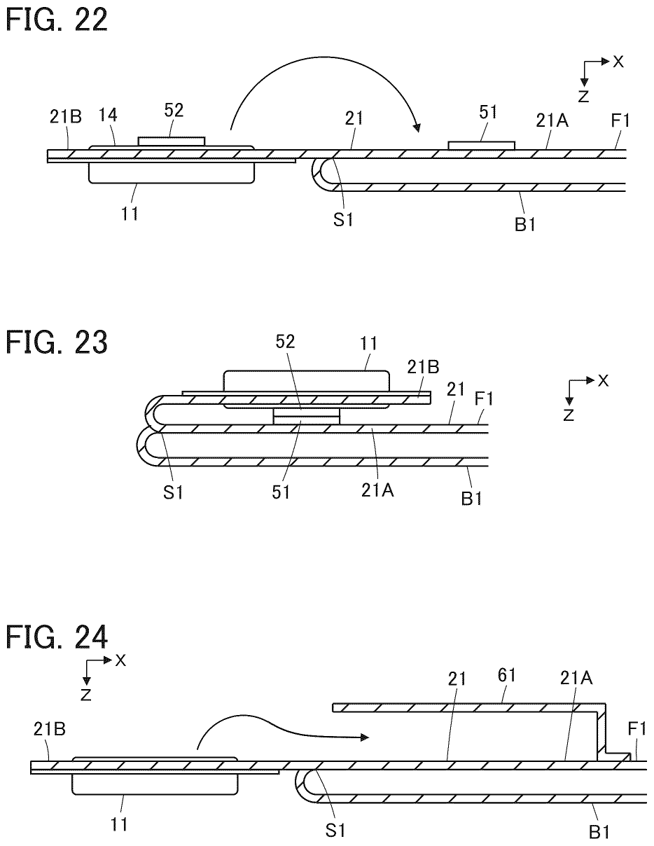

For instance, as shown in FIG. 22, it is possible that a first fixing member 51 is disposed on the rear surface side, facing in the −Z direction, of the base body 21A, and a second fixing member 52 is disposed on the rear surface, facing in the −Z direction, of the second insulator 14 of the connector 11 mounted on the tag portion 21B.

The first fixing member 51 and the second fixing member 52 can be fixed to each other and can be each formed of, for example, a snap button, a hook-and-loop fastener, and a magnet.

As shown in FIG. 23, the second fixing member 52 of the tag portion 21B that is folded to the rear surface side of the base body 21A is fixed to the first fixing member 51 of the base body 21A, whereby the tag portion 21B on which the connector 11 is mounted can be fixed to the rear surface side of the base body 21A. By fixing the folded tag portion 21B to the base body 21A in this manner, even the garment C1 provided with the tag portion 21B on which the connector 11 is mounted can be worn without uncomfortable feeling.

### Embodiment 6

In addition, as shown in FIG. 24, a connector accommodation portion 61 of bag-like shape can be disposed on the rear surface side of the base body 21A. The connector accommodation portion 61 is opened on its −X direction side where the tag portion 21B is situated, and has a size allowing the tag portion 21B on which the connector 11 is mounted to be accommodated therein.

The connector accommodation portion 61 as above can be formed of part of the cloth constituting the garment C1 or of a material different from the cloth of the garment C1.

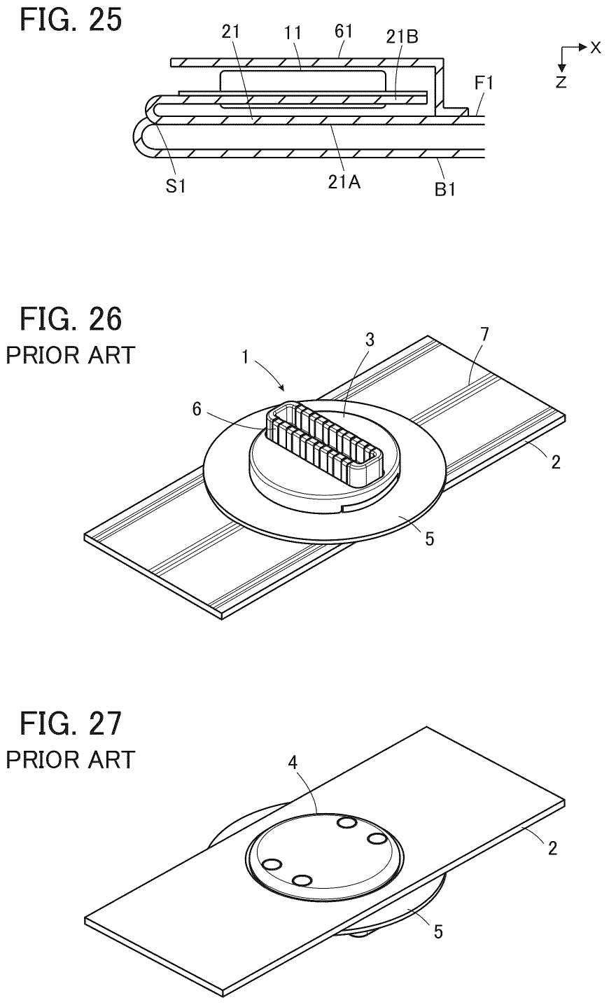

As shown in FIG. 25, the tag portion 21B folded to the rear surface side of the base body 21A is accommodated in the connector accommodation portion 61, whereby the tag portion 21B on which the connector 11 is mounted can be fixed to the rear surface side of the base body 21A. By fixing the folded tag portion 21B to the base body 21A in this manner, even the garment C1 provided with the tag portion 21B on which the connector 11 is mounted can be worn without uncomfortable feeling.

It is possible also in the garment C2 in Embodiment 2 to fix the tag portion 26B on which the connector 11 is mounted to the back body F2 by use of the method in Embodiment 5 or Embodiment 6.

Moreover, it is possible also in the garment C3 in Embodiment 3 to fix the tag portion 31B on which the connector 11 is mounted to the rear surface side of the base body 31A, i.e., the outer surface side of the waist portion G1 by use of the method in Embodiment 5 or Embodiment 6.

Furthermore, it is possible also in the electrical device E1 with pads in Embodiment 4 to fix the tag portion 41B on which the connector 11 is mounted to the rear surface side of the base body 41A, i.e., the outer side of the electrical device E1 with pads by use of the method in Embodiment 5 or Embodiment 6.

The connector assembly according to the invention can be applied to not only the garment C1, C2, C3 and the electrical device E1 with pads but also a wide variety of wearing articles worn by a user. In addition, by attaching the connector assembly according to the invention to a seat, a bed, a bedding piece, or the like in or on which a user lies, the connector 11 can be mounted without degrading comfortableness.

What is claimed is:

1. A connector assembly comprising:
a sheet-like base that is flexible, the sheet-like base including a base body and a tag portion drawn from the base body;
at least one terminal member disposed on a front surface of the base body;
at least one wire disposed to extend from the front surface of the base body to a front surface of the tag portion, the at least one wire having one end thereof connected to the at least one terminal member and another end thereof extending to the front surface of the tag portion; and
a connector mounted on the front surface of the tag portion and connected to the another end of the at least one wire,
wherein the tag portion is folded toward the base body such that a rear surface of the tag portion faces a rear surface of the base body, whereby the connector is disposed on the rear surface side of the base body.

2. The connector assembly according to claim 1, wherein the tag portion that is folded is sewn to the base body and thereby fixed to the base body.

3. The connector assembly according to claim 1, further comprising:
a first fixing member disposed on the rear surface side of the base body; and
a second fixing member disposed on the rear surface side of the tag portion and fixed to the first fixing member,
wherein the first fixing member and the second fixing member are fixed to each other, whereby the tag portion that is folded is fixed to the base body.

4. The connector assembly according to claim 1, further comprising a connector accommodation portion disposed on the rear surface side of the base body,
wherein the tag portion that is folded is accommodated together with the connector in the connector accommodation portion and thereby fixed to the base body.

5. The connector assembly according to claim 1, wherein the sheet-like base is formed of cloth of a garment.

6. The connector assembly according to claim 5,
wherein the garment includes a front body and a back body that are sewn to each other,
the base body is formed of the cloth constituting one of the front body and the back body, and
the tag portion is drawn from a sewing portion of the front body or the back body to an outside of the garment.

7. The connector assembly according to claim 6,
wherein the front surface of the base body is constituted of a surface, facing an inner side of the garment, of the one of the front body and the back body, and
the terminal member is composed of an electrode.

8. The connector assembly according to claim 6,
wherein the front surface of the base body is constituted of a surface, facing an outer side of the garment, of the one of the front body and the back body, and
the terminal member is composed of a sensor.

9. The connector assembly according to claim 8, wherein the tag portion that is folded is fixed to another one of the front body and the back body.

10. The connector assembly according to claim 5,
wherein the garment includes a waist portion adjacent to an opening portion,
the base body is formed of the cloth constituting the waist portion,
the front surface of the base body is constituted of a surface of the waist portion facing an inner side thereof, and
the tag portion is drawn from the opening portion to an outside of the garment.

11. The connector assembly according to claim 1, wherein the sheet-like base is formed of an insulating resin film.

12. A garment comprising the connector assembly according to claim 1,
wherein the sheet-like base is formed of at least part of cloth of the garment.

13. The garment according to claim 12, further comprising a front body and a back body that are sewn to each other,
wherein the base body is formed of the cloth constituting one of the front body and the back body, and
the tag portion is drawn from a sewing portion of the front body or the back body.

14. The garment according to claim 12, further comprising a waist portion adjacent to an opening portion,
wherein the base body is formed of the cloth constituting the waist portion, and
the tag portion is drawn from the opening portion.

15. An electrical device with a pad comprising the connector assembly according to claim 11,
wherein the at least one terminal member is composed of an electrode having a pad-like shape.
